(19) United States
(12) Patent Application Publication
(10) Pub. No.: US 2003/0021061 A1
(43) Pub. Date: Jan. 30, 2003

(54) Labyrinth seal for removable disk drive cartridge

(75) Inventor: David L. Hall, Salt Lake City, UT (US)

Correspondence Address: Michael K. Jones, WOODCOCK WASHBURN KURTZ, MACKIEWICZ & NORRIS LLP, One Liberty Place - 46th Floor, Philadelphia, PA, 19103, US

(73) Assignee: Iomega Corporation

(21) Appl. No.: 09/915,810

(22) Filed: Jul. 26, 2001

(51) Int. Cl. G11B 17/02

(52) U.S. Cl. 360/99.08

(57) ABSTRACT

A labyrinth seal arrangement for preventing contaminants from entering an interior of the removable cartridge. The labyrinth seal includes a sealing disk disposed external to the cartridge housing proximate the hub opening that acts to pump air away from the hub opening to prevent a flow of air and airborne contaminants, including dust, dirt, smoke, and the like, from being introduced into the removable cartridge through the area around the hub opening during operation of the cartridge. The sealing disk can be part of the removable cartridge or the disk drive. The cartridge can include a clamping mechanism for selectively moving the sealing disk between a static contact position over the hub opening during a non-operating condition and a dynamic spaced apart relation with the cartridge housing during an operating condition. The sealing disk can have substantially the same dimensions as the data storage disk or can have pumping features either of which is designed to create an air flow that negates the air flow created by the spinning data storage disk(s). The sealing disk functions to produce substantially no net air flow into or out of the cartridge housing around the hub during operation. Zero net air flow results in no contaminant introduction. By controlling the introduction of contaminants into the interior of the cartridge, the life and performance of the disk cartridge can be improved by allowing an increased track density and linear density. The sealing disk also improves the capacity of the disk cartridge by providing a more reliable surface on the bottom surface of the disk proximate the hub opening, which is typically the least reliable recording surface of the data storage media.

### FIELD OF THE INVENTION

The present invention relates in general to a removable disk drive cartridge, and particularly, to a labyrinth seal for reducing contaminant introduction into the removable cartridge.

### BACKGROUND OF THE INVENTION

A removable disk drive cartridge arrangement generally comprises a disk which may be a floppy disk or a generally rigid disk which is coated with a material upon which information can be stored, such as a magnetic material upon which information is magnetically stored. A housing, or shell, is provided about the disk to protect the disk from environmental contamination. The disk is mounted on a hub which is in turn mounted through the housing such that the hub can engage with a spindle of a disk drive unit. The housing includes a head aperture for allowing recording and reading heads to have access through the housing to the disk.

In designing a disk drive cartridge arrangement one should account for several considerations. For example, the cartridge is preferably designed in such a way that the possibility of contaminants entering the housing is minimized. Contaminants that are introduced into the cartridge housing can cause decreased performance of the removable cartridge by, for example, increasing the spacing between the heads and the disk surface (e.g., fly height), damaging the heads, damaging the media surface, and the like, all of which are undesirable.

In order to reduce the introduction of contaminants into the cartridge, the housing typically includes a door arrangement which closes over the read/write head aperture when the disk drive cartridge arrangement is not in use to prevent contamination from entering the housing when the cartridge is removed from the disk drive unit. However, the hub opening of the cartridge housing is typically not covered by any type of door arrangement.

During operation, the head aperture door arrangement is typically opened to allow the read write heads to access the disk. As the disk spins, an air flow is generated by the spinning disk and air flows axially and tangentially over and off of the surface of the spinning disk. This air flow creates an area of low pressure (e.g., a vacuum) proximate a center region of the disk in the area of the disk hub. This low pressure area creates a second flow of air from outside the housing into the cartridge housing through the space between the hub and the hub opening. This flow of air into the cartridge housing through the space around the hub opening is known to introduce contaminants into the cartridge.

In this regard, reference is made to U.S. Pat. No. 4,503,474, issued Mar. 5, 1985 to Nigam, which shows and describes a disk drive cartridge arrangement having a labyrinth seal arrangement for preventing contaminants from entering the interior of the housing. Nigam describes a hub means which includes a labyrinth seal means which is designed in such a way that the possibility of contamination of the disk can be reduced. As shown and described, the labyrinth seal means of Nigam includes a first hub disk that is part of the hub and is located immediately adjacent a lower side of the housing. The labyrinth seal means also includes a second hub disk which is located externally to the lower side, in a recess defined by the lower side. The first and second hub disks are spaced apart in substantially parallel planes by a spacer means extending therebetween. As shown in Nigam, the first and second hub disks are substantially smaller than the data storage disk. However, the labyrinth seal means disclosed in Nigam describes a conventional labyrinth seal means that redirects and changes the flow direction of a fluid or gas passing through the labyrinth seal, but does no stop the flow of air into the disk cartridge. Accordingly, the labyrinth seal disclosed by Nigam does not effectively prevent contaminants, especially smaller airborne contaminants (e.g., of about 0.005 μm or smaller) from entering the removable cartridge.

In addition, at the time of the invention of Nigam, the fly height of the head over the disk required that the labyrinth seal prevent contaminants bigger than about 0.5 μm in diameter from entering the cartridge. However, today's much lower fly heights (e.g., of about 0.005 μm) require that particles of a much smaller size be prevented from entering the cartridge. These smaller sized contaminants are easily carried by the air flow that Nigam is not capable of stopping.

In addition, on many prior art cartridge arrangements, the hub and disk are spring loaded against an interior of the housing to keep the disk from unduly moving (e.g., rattling) while the cartridge is removed from the disk drive. In this regard, reference is made to U.S. Pat. No. 5,650,899 issued Jul. 22, 1997 to Schick et al., which shows and describes a disk cartridge anti-rattle mechanism. When the cartridge is inserted into a disk drive, the hub can be urged upwardly as it is positioned over the spindle so that there is an opening formed between the hub and the housing. However, as the disk spins, a vacuum is created next to the surface of the spinning disk and contaminants can be drawn through this space. Obviously, such an arrangement is not advantageous.

Therefore, a need exists for a labyrinth seal for a removable cartridge that reduces and/or eliminates the introduction of contaminants into the removable cartridge through the space between the hub and the hub opening in the cartridge housing. Also, a need exists for preventing much smaller (e.g., about 0.005 μm and smaller) contaminants from entering the disk cartridge.

### SUMMARY OF THE INVENTION

The present invention is directed to a removable cartridge having a labyrinth seal for reducing an introduction of contaminants into the cartridge. The removable cartridge includes a cartridge housing having a top surface, a bottom surface, and side walls extending between and connecting the top surface and the bottom surface. One or more data storage disks are rotatably disposed within the housing. A hub opening is formed in the bottom surface of the housing. A hub is connected to the data storage disk(s) and is accessible through the hub opening. When the cartridge is inserted into a disk drive and is in operation (e.g., the disk, or disks, are rotating within the cartridge), a clearance or space is formed around the annular opening formed between the hub and the hub opening. A sealing disk is positioned proximate the hub opening, external to the removable cartridge for preventing contaminants from entering the housing through the clearance around the hub and the hub opening.

The sealing disk is positioned external to the cartridge housing proximate the hub opening. The spinning sealing disk acts to pump air away from the hub opening. A first flow of air is formed by a rotation of the data storage disk and a second flow of air is formed by a rotation of the sealing disk. The second flow of air functions to counteract the first flow of air such that there is substantially no net flow of air into or out of the housing through the hub opening. Therefore, during operating, the sealing disk and the data storage disk each generate a flow of air such that there is substantially no net flow of air around or through the hub opening thus preventing/reducing any flow of contaminants into the cartridge through the hub opening.

In one embodiment, the sealing disk includes a disk shaped body having substantially the same dimensions as the data storage disk. Preferably, the sealing disk has substantially the same diameter as the data storage disk. The clearance between the data storage disk and the cartridge housing is substantially equal to the clearance between the sealing disk and the cartridge housing.

In another embodiment, the sealing disk includes a disk shaped body having pumping features. The pumping features are preferably disposed on the side of the sealing disk proximate the cartridge housing and acts to pump air away from the hub opening. In embodiments having a sealing disk with pumping features, the sealing disk may have smaller dimensions than the data storage disks due to the pumping action of the pumping features. The clearance between the sealing disk and the cartridge housing can be smaller than the clearance between the data storage disk and the cartridge housing again due to the pumping features. This helps reduce the Z height of the removable cartridge and/or the drive system.

The sealing disk may be part of the removable cartridge or part of the disk drive. In one embodiment wherein the sealing disk is part of the removable cartridge, the sealing disk can be connected to the hub external to the cartridge housing. In an embodiment wherein the sealing disk is part of the disk drive, the sealing disk can be connected to the spindle of the disk drive so that when the spindle engages the hub, the sealing disk is disposed proximate the hub opening.

In accordance with another aspect of the present invention, the sealing disk can be selectively movable between a non-operating position and an operating position. In the non-operating position, the sealing disk is in static contact with the housing thereby preventing an introduction of contaminants into the housing. In the operating position, the sealing disk is in dynamic spaced relation with the housing, and the sealing disk and the data storage disk each generate a flow of air such that a flow of contaminants into the cartridge is prevented/reduced. In other words, during operation the sealing disk creates an air flow that opposes and is substantially equal to the air flow created by the data storage disk so that there is substantially no net flow of air around or through the hub opening. Preferably, the data storage disk and the sealing disk move together as the hub moves and engages the spindle of a disk drive.

In accordance with another aspect of the present invention, the cartridge also includes a ledge extending from a periphery of a planar surface of the housing. The ledge can extend to a free end that forms a plane that is substantially parallel to a planar surface of the housing and the sealing disk is positioned between the planar surface of the housing and the plane defined by the free end of the ledge.

In accordance with a further aspect of the present invention, the cartridge includes an inner flange portion that extends from a side wall of the cartridge housing inwardly to an inner edge, the inner edge defining the hub opening. In an embodiment wherein the sealing disk is positioned outside the cartridge housing, the flange preferably extends at least some distance between the data storage disk and the sealing disk.

In accordance with a further aspect of the present invention, the removable cartridge assembly includes a clamping mechanism for restraining the sealing disk against the cartridge housing when the cartridge is removed from a disk drive unit and for freeing the sealing disk for rotation when the cartridge is inserted into a disk drive unit. The clamping mechanism can include a cam rotatable on the same axis as the data storage disk, the cam having a surface which extends axially to contact and clamp the sealing disk when the cam is rotated. The clamping mechanism can include a translating cam follower which is moved axially by the cam to clamp the sealing disk against one planar surface of the housing. Preferably, the cam is connected to a door covering a head aperture to rotate the cam as the door is moved between an open and a closed position. The movement of the cam can selectively retain and free the sealing disk for rotation.

The foregoing and other aspects of the present invention will become apparent from the following detailed description of the invention when considered in conjunction with the accompanying drawings.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings embodiments that are presently preferred, it being understood, however, that the invention is not limited to the specific methods and instrumentalities disclosed. In the drawings:

FIG. 1A shows a top view of an exemplary removable cartridge having a labyrinth seal of the present invention;

FIG. 1B shows a bottom view of the exemplary removable cartridge of FIG. 1A;

FIG. 2 shows a front view of the removable cartridge of FIG. 1;

FIG. 3 is an isometric view of the cartridge of FIG. 1 with the top shell removed;

FIG. 4 is a perspective view of a device in which the invention can be used;

FIG. 5 shows an exemplary labyrinth seal for use with the cartridge of FIG. 1 in an operating position;

FIG. 6 shows the labyrinth seal and cartridge of FIG. 1 in a non-operating position;

FIG. 7 shows an exemplary sealing disk having pumping features in accordance with the present invention;

FIG. 8 shows an exemplary labyrinth seal having an extended ledge for protecting the sealing disk;

FIG. 9 shows an alternative labyrinth seal and cartridge arrangement for a cartridge having two data storage disks;

FIG. 10 shows another alternative labyrinth seal arrangement wherein the sealing disk is mounted to the disk drive; and

FIG. 11 illustrates the contrast between a sealing disk having substantially the same dimensions as the data storage disk and a sealing disk having pumping features.

### DESCRIPTION OF EXEMPLARY EMBODIMENTS AND BEST MODE

The present invention is directed to a labyrinth seal arrangement that can be used with a removable cartridge for preventing contaminants from entering an interior of the removable cartridge. The labyrinth seal includes a sealing disk that acts as an air pump to prevent a flow of air and airborne contaminants, including dust, dirt, smoke, and the like, from being introduced into the removable cartridge through the clearance or space around the hub and hub opening. In one preferred embodiment of the present invention, a sealing disk is provided that is substantially the same size as the data storage disk. In another embodiment, the sealing disk includes pumping features and may have a smaller diameter than the data storage disk.

The sealing disk produces an air flow as it spins which counteracts any air flow created by the spinning data storage disk so that there is substantially no net air flow into or out of the cartridge housing around the hub opening. Zero net air flow results in no contaminant introduction. By controlling the introduction of contaminants into the interior of the cartridge, the performance of the disk cartridge can be improved by allowing an increased track density and linear density. The use of a sealing disk to reduce the introduction of contaminants into the cartridge results in longer head and media lives owing to the lower damage rates. The sealing disk also improves the capacity of the disk cartridge by providing a more reliable surface on the bottom surface of the data storage disk proximate the hub opening, which is typically the least reliable recording surface of the data storage media.

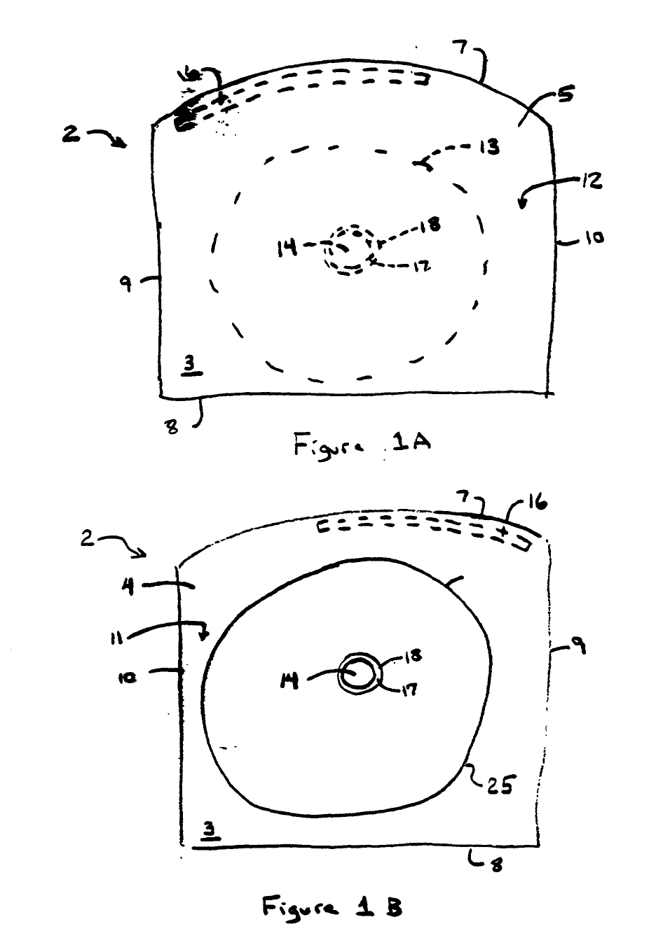

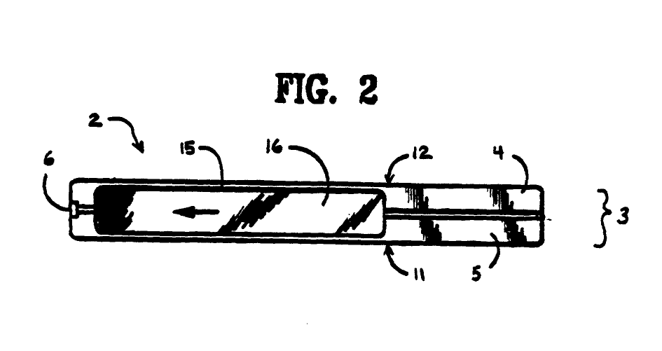

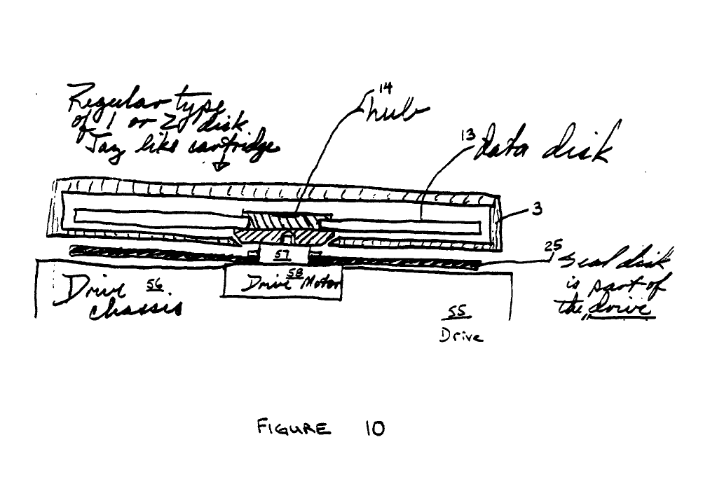

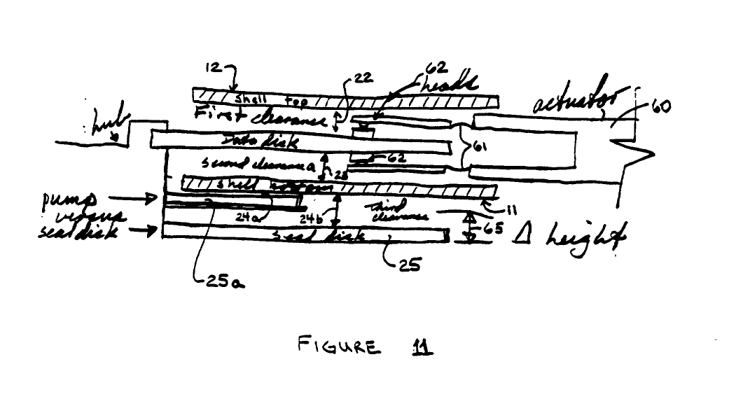

FIGS. 1 through 3 show an exemplary cartridge 2 including a housing, or shell, 3 having a lower half shell 4 and an upper half shell 5 joined together at 6. The cartridge 2 has a front 7, a back 8 and two sides 9 and 10 formed between substantially flat, planar surfaces 11 and 12. The cartridge 2 can include one or more disk-shaped recording medium 13, which are affixed to a hub 14 that is rotatably mounted in the housing 3. The disk 13 may be a floppy disk or a generally rigid disk which is coated with a material upon which information can be stored. The disk 13 can be any type of data storage disk including, for example, magnetic, optical, and the like. The cartridge 2 may contain more than one disk 13. FIG. 9 shows a cartridge 2 having two disk-shaped recording medium 13, 13A. The disk can be mounted on a hub 14 which is in turn rotatably mounted in the housing 3 such that the hub 14 can engage with a spindle 57 of a disk drive unit 55 (see FIG. 10).

A head access aperture 15 in the front 7 of the cartridge 2 provides access to the recording surfaces of the disk 13 by the read/write heads of a disk drive (not shown). A movable door 16 covers the head access aperture 15 when the cartridge is removed from the drive. A hub opening 18 is formed in the cartridge housing 3 to provide access to the hub 14 for rotating the disks. As shown, the hub opening can be formed in the bottom shell 4 of the housing 3. When the cartridge is inserted into a disk drive and the disk hub 14 and disks 13 are spinning, an annular ring clearance 17 is formed between the hub 14 and the cartridge housing 3 which allows the hub to rotate and spin the disks within the housing without contact.

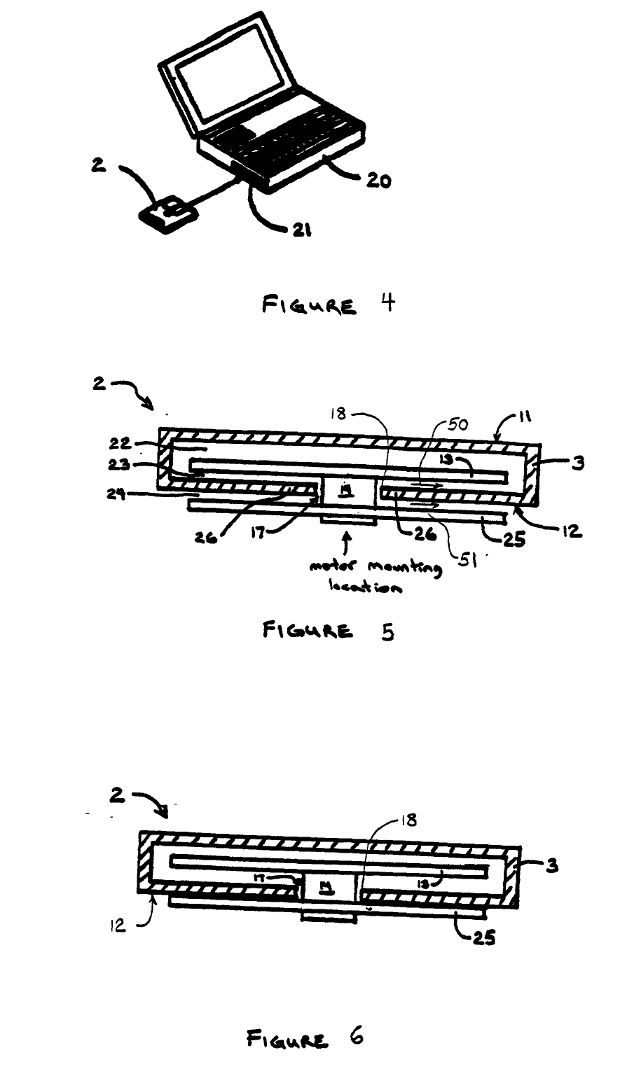

FIG. 4 shows a laptop computer 20 which has a disk drive 21 for receiving the disk cartridge 2 of FIG. 1. The drive 21 may be any suitable disk drive such as, for example, the Iomega ZIP drive which is disclosed and claimed in the U.S. patents identified in U.S. Pat. No. 5,638,228, which is incorporated herein by reference, the Iomega JAZ drive which is disclosed and claimed in the U.S. patents identified in U.S. Pat. No. 5,650,899, which is herein by incorporated by reference, or the like.

A sealing disk 25 is provided that functions to prevent contaminants from being introduced into the interior of the cartridge by pumping air away from the hub opening 18 and the annular ring clearance 17 while the disks are spinning. The sealing disk 25 acts as a dynamic labyrinth seal when the cartridge is in operation (e.g., when the disks are spinning) in a disk drive unit. The sealing disk 25 can also act as a static seal or cover over the hub opening 18 when the cartridge is removed from a disk drive unit. The sealing disk 25 includes a generally disk shaped body and can be positioned external to the cartridge housing 3 proximate the hub opening 18 and the annular ring clearance 17.

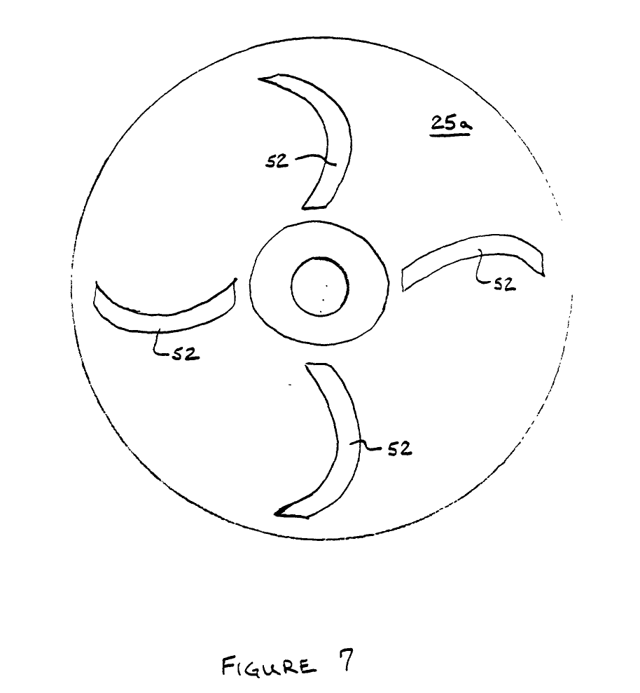

The sealing disk 25 can comprise any material which is suitable for use with a disk cartridge and for use in a disk drive having high rotational speeds, such as for example a plastic material, a metal material, or the like. The sealing disk 25 provides a non-precision and relatively inexpensive disk for controlling the air flow around the hub opening of the cartridge. The sealing disk 25 can be mounted to the hub 14 of the removable disk drive cartridge 2 (see FIGS. 5 and 6). Alternatively, the sealing disk 25 can be mounted to the disk drive, such as for example, the spindle of the disk drive (see FIG. 10).

FIG. 5 shows a first exemplary embodiment of the labyrinth seal arrangement of the present invention for preventing the introduction of contaminants into a cartridge 2. As shown in FIG. 5, the labyrinth seal arrangement is part of the removable cartridge 2 and includes the cartridge housing 3, one or more data storage disks 13 having a recording media disposed thereon, a hub 14 to which the data storage disk 13 are mounted and which is rotatably mounted in the cartridge housing 3, a hub opening 18 in the housing 3 for accessing the hub for engagement with a drive of a disk drive unit, and a sealing disk 25 disposed external to the cartridge housing and disposed proximate the hub opening 18. As shown in FIG. 5, the sealing disk 25 is connected to the hub 14. FIG. 10 shown an alternative embodiment wherein the sealing disk 25 is connected to the disk drive 55.

As shown in FIGS. 5 and 6, in one embodiment, the sealing disk 25 has substantially the same dimensions as the data storage disk 13. More preferably, the sealing disk 25 has substantially the same diameter as the diameter of the data storage disk 13. As shown, the sealing disk is positioned outside (e.g., externally) the disk cartridge 2. It is preferred that the sealing disk 25 and the data storage disk 13 have substantially the same dimensions and characteristics such that a flow of air generated by each of the spinning disks functions to counteract or cancel out one another such that substantially no net air flow is generated by the spinning disks into or out of the cartridge. The data storage disk 13 and the sealing disk 25 act as air pumps as they spin at the same speed on the hub 14.

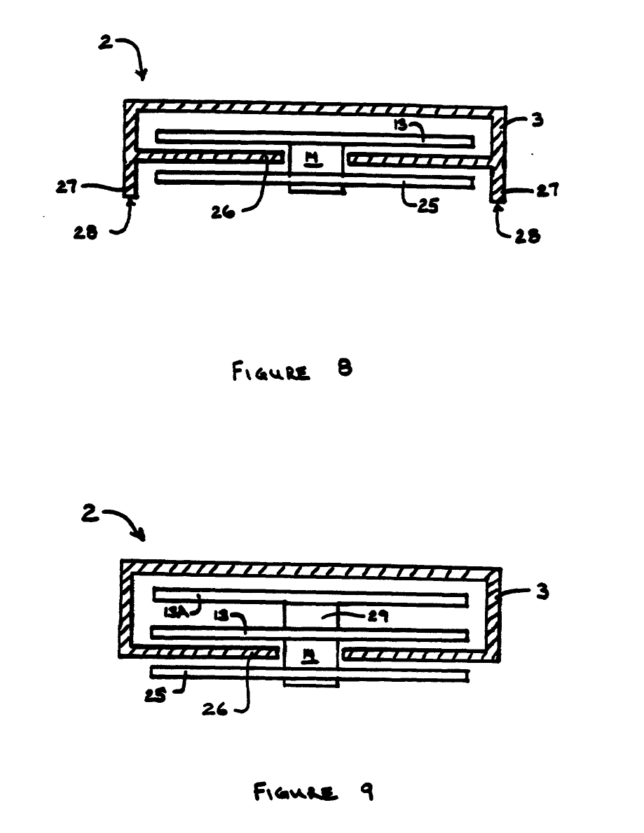

In another embodiment shown in FIG. 7, the sealing disk 25a can include pumping features 52 to enhance the creation of an air flow generated by the spinning motion of the sealing disk. The combination of the dimensions of the sealing disk 25a and the pumping features 52 combine to create an air flow that counteracts and cancels the air flow created by the spinning data storage disk 13. Although four equally space pumping features 52 that extend in a curved arch from an inner diameter of the sealing disk 25a to an outer diameter are shown in FIG. 7, any number, size, and shape can be provided so long as the sealing disk 25a creates an air flow that is substantially the same as the air flow created by the spinning data storage disk. The pumping features 52 allow the sealing disk 25a of this embodiment to have smaller dimensions than the data storage disk 13 due to the presence and pumping action of the pumping features 52. One suitable design for a sealing disk 25a having pumping features 52 is an impeller type design having a plurality of vanes as the pumping features 52 (such as found on a centrifugal pump).

The pumping features 52 allow the sealing disk 25 a to pump like a smooth disk while at the same time allowing the sealing disk 25a to have smaller dimensions (e.g., a smaller diameter) than the dimensions of the data storage disk. For example, the sealing disk 25a having pumping features 52 can include a design similar to an impeller of a pump and the like. The sealing disk 25a can have a diameter ½ or 1/n the size of the data disk depending on the number and design of the pumping features 52. Also, the clearance between the sealing disk and the cartridge housing may be smaller (e.g., tighter), thereby reducing the Z height of the removable cartridge, which is desirable (see FIG. 11). In addition, the sealing disk 25a having pumping features can be included in either the removable cartridge or the disk drive.

Referring back to FIG. 5, as the data storage disk 13 and the sealing disk 25 spin, a first flow of air (represented by arrow 50) and a second flow of air (represented by arrow 51) each having a radial and a tangential component are generated by the spinning data storage disk 13 and the sealing disk 25, respectively. The first flow of air 50 and the second flow of air 51 pump air away from the hub opening 18 and the annular ring clearance 17. These air flows 50, 51 cause air proximate the surface of each disk to flow generally outwardly off the disk surfaces. This creates an area of low pressure (e.g., a vacuum) proximate a center region of each disk near the hub opening 18 and the annular ring clearance 17. However, since the data storage disk 13 is located inside the cartridge and the sealing disk 25 is located outside the cartridge, these air flows 50, 51 act to negate or cancel each other out in the area around the hub opening, and as a result, substantially no net flow of air is generated between the inside and the outside of the cartridge through the hub opening 18 and the annular ring clearance 17. Since air is not flowing into the cartridge, contaminants, especially airborne contaminants, are not introduced into an interior of the cartridge.

As shown in FIG. 5, the cartridge 2 is in an operating position. In the operating position, the data storage disk 13 and the sealing disk 25 are positioned in parallel spaced relation with respect to the substantially flat, planar surfaces 11, 12 of the cartridge 2. When in operation, a first clearance 22 is provided between the top planar surface of the cartridge and a top surface of the upper most data storage disk. A second clearance 23 is provided between the bottom surface of the lowest most data storage disk and the bottom planar surface of the cartridge. A third clearance 24 is provided between a top surface of the sealing disk and the bottom planar surface of the cartridge. The number of disks will determine the number of clearances. The clearances allow the data storage disk and the sealing disk to rotate without contacting the cartridge housing and also allow read/write heads of a disk drive to access either side of each data storage disk.

Preferably, in an embodiment where the sealing disk 25 has substantially the same diameter as the data storage disk 13, the clearance between the bottom surface of the lowest most data storage disk and the bottom shell of the cartridge (e.g., the second clearance 23 of FIG. 5) and the clearance between a top surface of the sealing disk and the bottom shell of the cartridge (e.g., the third clearance of FIG. 5) are substantially equal.

In addition, the disks and cartridge act as a dynamic labyrinth seal wherein motion exists as between the hub 14 and disks 13, 25, which are spinning and an adjoining inner flange portion 26 of the cartridge planar surface 12 which is stationary. The data storage disk 13 and the sealing disk 25 act as rotating labyrinths and the inner flange portion 26 acts as a fixed labyrinth to further prevent the introduction of contaminants. The inner flange portion 26 extends to an inner edge which defines the hub opening 18. Preferably, the inner flange portion 26 preferably extends at least some distance into the space defined between the lower most data storage disk 13 and the sealing disk 25. More preferably, the inner flange 26 ends proximate the hub.

FIG. 6 shows the sealing disk and cartridge arrangement in a non-operating position. In the non-operating position, the sealing disk 25 is moved to make contact with the planar surface 12 of the cartridge 2 to prevent the introduction of contaminants. In the non-operating position, the sealing disk 25 forms a static seal around the hub opening 18 and no motion takes place as between the sealing disk and the cartridge. Preferably, a clamping mechanism 30 causes the sealing disk 25 to come into contact with the cartridge 2 to prevent contaminants from being introduced through the hub opening 18 into an interior of the cartridge when the cartridge 2 has been removed from the disk drive unit. As shown in FIG. 6, the hub assembly 14, including the data storage disk 13 and the sealing disk 25, can be moved upward such that the top surface of the sealing disk 25 makes contact with the bottom planar surface 12 of the cartridge 2, thereby sealing the hub opening 18.

U.S. Pat. No. 5,650,899 issued Jul. 22, 1997 to Schick et al. is an example of one suitable clamping mechanism 30 that can be used with the present invention and is incorporated herein by reference in its entirety. Schick et al. describe a cam mechanism to clamp a magnetic disk against a cartridge shell.

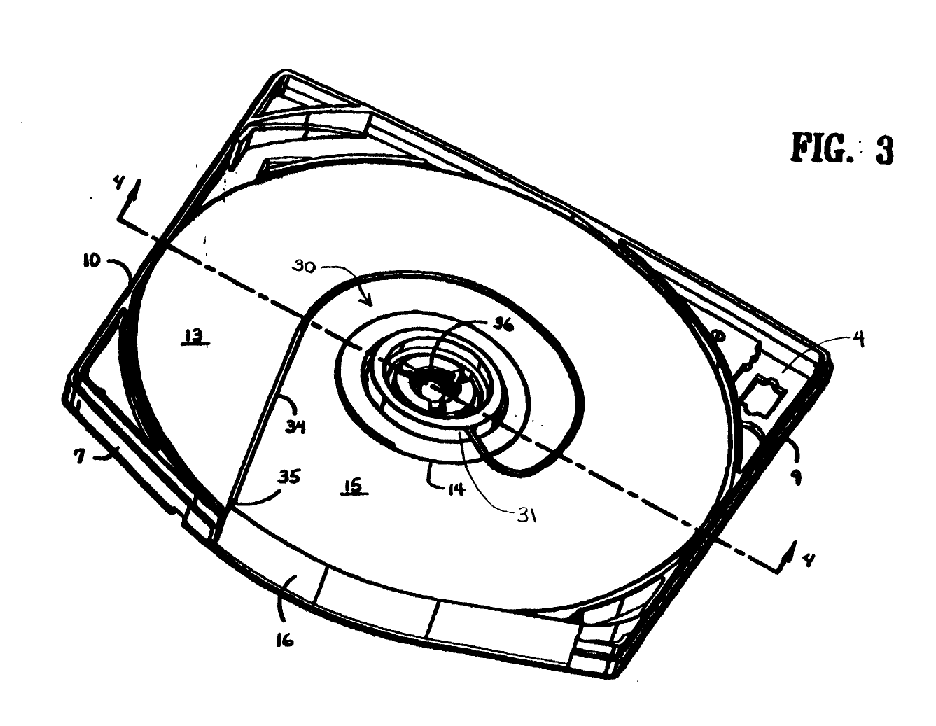

Referring to FIG. 3, shown is a clamping mechanism 30 can be actuated as the head access door 16 is opened and closed. This clamping mechanism 30 can include a rotating cam 31 which can be rotatable on the same axis as the disk 13. The cam has a surface which extends axially as a function of the circumference of the cam. A translating cam follower (not shown) moves axially by the surface as the cam rotates. This axial movement clamps the sealing disk 25 against the bottom planar surface 11 of the bottom half 5 of the housing 3 in the position shown in FIG. 6.

As shown in FIG. 3, the rotating cam 31 can be connected to the door 16 by the actuating wire 34. Actuating wire 34 provides a spring coupling which allows for overtravel at both ends of the stroke of the door 16. Spring 34 also provides for relative changes in the distance between the cam 31 and the point 35 at which the actuating wire 34 is attached to the door 16. This distance varies as the door travels through its stroke.

A retaining spring 36 can be positioned co-axially with the hub 14. The retaining spring 36 can apply torsion to the hub 14 to return it to the position shown in FIG. 3 after it has been translated by the cam follower. A compression spring (not shown) can apply bias to the cam follower to return it. A second spring (not shown), which can be concentric with, but outside of, the first spring, can provide a return force for the cam follower to bring it into its open position. The cartridge preferably has a cavity at the center thereof in which the clamping mechanism 30 is positioned.

When the cartridge 2 is inserted into a disk drive 55, the cam follower is moved in order to allow the disk hub 14 to rotate within the cartridge. An annular ring clearance 17 is formed at the interface between the disk hub 14 and the cartridge housing 3.

FIG. 8 shows the cartridge and labyrinth seal arrangement of FIG. 5 further including a ledge 27 for protecting the external sealing disk. As shown in FIG. 8, the cartridge can include an extended ledge 27 that extends from a peripheral edge of the planar surface of the cartridge 2 on which the sealing disk 25 is positioned. Preferably, the ledge 27 extends from the cartridge a distance greater than the sealing disk so that the sealing disk is positioned between the cartridge shell and the plane formed by the free end of the ledge 27. This helps to protect the seal disk when the cartridge is removed from a disk drive and is not being used. Preferably, one end of the ledge 27 can be connected to the cartridge and the ledge can extend to a free end 28 that forms a plane that is substantially parallel to the flat planar surface 12 of cartridge 2. The sealing disk 25 is positioned between the flat planar surface 12 and the plane defined by the free end 28 of the ledge 27. The ledge 27 is preferably constructed to have a height sufficient to protect the sealing disk 25, while at the same time, having a height that does not add unnecessarily to the overall height of the cartridge 2.

FIG. 9 shows an exemplary cartridge embodiment having more than one data storage disk. As shown in FIG. 9, two recording disks 13 and 13A and sealing disk 25 are mounted on hub 14. In this embodiment wherein the cartridge has two data storage disks, a spacer 29 can be used to separate the disks 13 and 13A and the sealing disk 25.

FIG. 10 shows an exemplary embodiment having the sealing disk 25 included as part of the disk drive 55. As shown in FIG. 10, the sealing disk 25 disposed in the chassis 56 of the disk drive 55 and is connected to the spindle 57 that is driven by the drive motor 58. In this embodiment, the cost of the single sealing disk 25 is included with the cost of the drive 55 and not with individual removable disk cartridges 2. This embodiment helps to reduce the costs and height of the removable disk cartridge.

FIG. 11 illustrates a sealing disk 25 having substantially the same dimensions and a sealing disk 25a having pumping features. As shown, a first clearance 22 and a second clearance 23 are provided above and below the data storage disk 13, respectively for allowing the read/write heads 62 attached to actuator 60 by arms 61 to read or write to the data storage disk 13. When a sealing disk 25 having substantially the same dimensions is used, then the third clearance 24a between the surface of the cartridge 12 and the sealing disk 25 is preferably the same as the second clearance 23. When a sealing disk 25a having pumping features is used, then the third clearance 24b between the surface of the cartridge 12 and the sealing disk 25 can be smaller than the second clearance 23. As shown in FIG. 11, the use of a sealing disk 25a having pumping features 52 results in differential height 65 and a lower overall height of the removable disk cartridge 2.

Although illustrated and described herein with reference to certain specific embodiments, the present invention is nevertheless not intended to be limited to the details shown. Rather, various modifications may be made in the details within the scope and range of equivalents of the claims and without departing from the invention.

What is claimed is:

1. A labyrinth seal for use with a removable cartridge comprising:
a housing;
one or more data storage disks rotatably disposed within said housing;
a hub rotatably disposed in said housing and connected to said one or more data storage disks;
a hub opening in said housing for accessing said hub for rotating said one or more data storage disks; and
a sealing disk rotatably disposed proximate said hub opening, wherein said sealing disk is oriented substantially parallel to said one or more data storage disks and is positioned proximate said hub opening outside of said housing;
wherein said sealing disk acts to prevent an introduction of contaminants into said housing of said removable cartridge through said hub opening.

2. The labyrinth seal of claim 1, further comprising:
a first flow of air formed by a rotation of said data storage disk; and
a second flow of air formed by a rotation of said sealing disk, wherein said second flow of air counteracts said first flow of air such that there is substantially no net flow of air into or out of said housing through said hub opening.

3. The labyrinth seal of claim 1 wherein said sealing disk is connected to said hub of said removable cartridge.

4. The labyrinth seal of claim 1 wherein said sealing disk is connected to a spindle of a disk drive that engages and rotates said hub of said removable cartridge.

5. The labyrinth seal of claim 1, wherein said sealing disk is in static contact with said housing in a non-operating condition and is in dynamic spaced relation with said housing during an operating condition.

6. The labyrinth seal of claim 1, further comprising an annular ring clearance formed between said hub opening and said hub.

7. The labyrinth seal of claim 1, wherein said sealing disk acts to pump air away from said hub opening and an annular ring clearance during said operating condition.

8. The labyrinth seal of claim 1, wherein said sealing disk has dimensions that are substantially the same as the dimensions of said data storage disk, and wherein a first clearance formed between said data storage disk and a bottom planar surface of said housing is substantially the same as a second clearance formed between said bottom planar surface of said housing and said sealing disk when said hub is rotating.

9. The labyrinth seal of claim 1, wherein said sealing disk further comprises pumping features on a surface of said sealing disk proximate said housing that act to pump air away from said hub opening as said sealing disk rotates.

10. The labyrinth seal of claim 9, wherein said sealing disk has dimensions that are smaller than the dimensions of said data storage disk, and wherein a first clearance formed between said data storage disk and a bottom planar surface of said housing is greater than a second clearance formed between said bottom planar surface of said housing and said sealing disk when said hub is rotating.

11. The labyrinth seal of claim 3, further comprising a ledge formed on a side of said housing on which said sealing disk is positioned, wherein said ledge extends from a periphery of said housing and a free end of said ledge forms a plane that extends from said housing beyond said sealing disk.

12. The labyrinth seal of claim 1, further comprising an inner flange portion that extends at least some distance between said data storage disk and said sealing disk.

13. The labyrinth seal of claim 12, wherein said inner flange portion extends between said data storage disk and said sealing disk from a side wall of said cartridge housing inwardly to an inner edge, said inner edge defining said hub opening.

14. The labyrinth seal of claim 1, further comprising an inner flange portion that extends between said data storage disk and said sealing disk to a non contact point immediately adjacent said hub.

15. The labyrinth seal of claim 1, further comprising a clamping mechanism for restraining said sealing disk against said cartridge housing when said cartridge is removed from a disk drive unit and for freeing said sealing disk for rotation when said cartridge is inserted into a disk drive unit.

16. The labyrinth seal of claim 1, wherein each of said one or more data storage disks comprises one of a magnetic data storage disk and an optical data storage disk.

17. A removable cartridge having a labyrinth seal for reducing the introduction of contaminants into said cartridge comprising:
a cartridge housing having a top surface, a bottom surface, and side walls extending between and connecting said top surface to said bottom surface;
a hub opening in said bottom surface of said cartridge housing;
one or more data storage disks rotatably disposed within said cartridge housing;
a hub connected to said data storage disks in said cartridge housing, said hub being accessible through said hub opening;
an annular ring clearance being formed between said hub and said cartridge housing when said one or more data storage disks are rotating within said cartridge housing; and
a sealing disk connected to said hub proximate said hub opening and said annular ring clearance for preventing contaminants from entering said housing through said annular ring clearance.

18. The removable cartridge having a labyrinth seal of claim 17, wherein said sealing disk is selectively movable between:
a non-operating position wherein said sealing disk is in static contact with said housing thereby preventing an introduction of contaminants into said housing; and
an operating position wherein said sealing disk is in dynamic spaced relation with said housing and said data storage disk generates a first flow of air internal to said cartridge housing away from said hub opening and said sealing disk generates a second flow of air external to said cartridge housing away from said hub opening such that there is substantially no net flow of air through said annular ring clearance.

19. The removable cartridge having a labyrinth seal of claim 17, wherein said sealing disk has substantially the same dimensions as said one or more data storage disks.

20. The removable cartridge having a labyrinth seal of claim 17, wherein said sealing disk further comprises pumping features for helping to generate a flow of air that is substantially equal to a flow of air generated by said one or more data storage disk as said sealing disk and said one or more data storage disks rotate.

21. The removable cartridge having a labyrinth seal of claim 17, further comprising a ledge extending from a periphery of a planar surface of said housing, wherein said ledge extends to a free end that forms a plane that is substantially parallel to said planar surface of said housing and wherein said sealing disk is positioned between said planar surface of said housing and said plane formed by said free end of said ledge.

22. The removable cartridge having a labyrinth seal of claim 18, further comprising a clamping mechanism for selectively moving said sealing disk between said non-operating position and said operating position.

23. The removable cartridge having a labyrinth seal of claim 17, wherein said sealing disk, said data storage disk, and said cartridge form a dynamic labyrinth seal in an operating condition proximate said hub opening and said annular ring clearance to produce substantially zero net flow of air into or out of said cartridge housing through said annular ring clearance.

24. A method of dynamically sealing a hub opening of a removable cartridge to prevent the introduction of contaminants into said cartridge comprising:
providing a cartridge housing having one or more data storage disks rotatably disposed therein on a hub that is accessible from outside said cartridge housing via a hub opening in said cartridge housing;
providing a sealing disk external to said cartridge housing and rotatably disposed proximate said hub opening;
generating a first flow of air internal to said cartridge housing and away from said hub opening by spinning a bottom most data storage disk of said one or more data storage disks;
generating a second flow of air external to said cartridge housing and away from said hub opening by spinning said sealing disk;
wherein said first flow of air and said second flow of air act to negate or cancel each other out in an area around said hub opening, resulting in substantially no net flow of air into or out of said hub opening.
